(19) United States
(12) Patent Application Publication
(10) Pub. No.: US 2015/0203624 A1
(43) Pub. Date: Jul. 23, 2015

(54) SECOND GENERATION HYBRID SILANE MODIFIED POLYMERS OF LOW VISCOSITY FOR LOW TOXICITY RTV SEALANTS AND ADHESIVES

(71) Applicant: Vladimyr Wolan, Glen Iris (AU)

(72) Inventor: Vladimyr Wolan, Glen Iris (AU)

(21) Appl. No.: 14/160,232

(22) Filed: Jan. 21, 2014

(51) Int. Cl. C08G 18/83; C09J 175/08

(52) U.S. Cl. CPC C08G 18/837; C09J 175/08

(57) ABSTRACT

The present method relates to the production of alcoxysilane capped polymers, as well as the production of sealants and adhesive using the alcoxysilane capped polymers formed from the present method. The method of production results in final alcoxysilane capped polymers that have a low viscosity and are safer for manufacturers, and end users.

### FIELD OF THE INVENTION

The present invention is a development relating to the silyl modified compositions of alkoxysilane cross linkable or end capped polyether and alkoxysilane modified polyurethane polymers where one or more urethane groups are present.

### BACKGROUND OF THE INVENTION

Over the past 25 years, moisture curable alkoxysilane terminated Polypropylene Glycol (polyether) and polyurethane polymers have been developed to replace standard isocyanate capped polyurethane (PU) prepolymers in one component of Room Temperature Vulcanised (RTV) moisture curing compositions. These lower toxicity polymers have been demonstrated to be an alternative to replace older technology polyurethane prepolymers with the benefits of better physical properties such as: UV resistance; adhesion to certain substrates with no primers; and a marked reduction in bubbling of sealant when curing. There has been almost complete replacement of the older PU sealants in some markets such as the aftermarket windscreen sealant segment. The first generation alkoxysilane capped difunctional polymers, without a urethane group present, have mostly replaced the traditional Toluene Di-isocyanate (TDI) based PU sealant. A significant advantage of these silane modified polyether polymers is their UV resistance resulting from the lack of aromatic molecules in the chain. However, the high tin content catalysis, moisture sensitivity over time and high monol polyether content of these first generation polymers have limited the replacement of PU prepolymer and silicone based sealants and adhesives in other sealant markets, such as the higher volume construction and adhesive markets.

An alternate polymer design was introduced where NCO (Nitrogen, Carbon, Oxygen) terminated polyurethane prepolymer was capped with secondary amino propyl trimethoxy silanes of various types. This alternative polymer design containing NCO terminated polyurethane prepolymers demonstrated the benefits of faster crosslinking of the trimethoxy silane, lower tin content requirement for curing the alkoxysilane, and the significant benefits of low monol Double Metal Cyanide (DMC) process in high molecular weight polyethers. This type of polymer design allowed the use of high Diisodecyl Phthalate (DIDP) plasticizer content similar to what is used in standard PU prepolymers. The use of DIDP plasticizers has the advantages of producing sealants and adhesives with good elastic recovery and low tin catalyst content. These NCO terminated polyurethane systems are a good alternate to PU prepolymers. However, they do have some disadvantages, the most significant being the high polymer viscosity due to the formation of urea groups when these secondary amino alkoxysilane end cappers are used.

The urea groups present in the polymer chain create hydrogen bonding between the chains, which increases the viscosity of the sealant. Typically, viscosity is in the range of 75,000 Mpas to 150,000 Mpas, with the need to use plasticizer contents of at least 20 percent in the prepolymer to make the prepolymer pourable at 20 to 30 degree Celsius temperatures. Drums of these polymers are impossible to empty satisfactorily without heating in colder climates.

The alternate moisture curable alkoxysilane polymers with lower polymer viscosity than the above mentioned amino silane based polymers are now commonly developed using high molecular weight, low monol polyether polyols where the hydroxyl end group is end capped with isocyanato silanes. Here, the viscosity is due to the long chain of the base polyether, which can be a result of some chain extension using a diisocyanate molecule and also the hydrogen bonding by the urethane group formed when the isocyanato silane NCO reactive group reacts with the hydroxyl group. The known polymers using this design commonly have viscosities in the range of 30000 to 75000 Mpas depending on the average molecular weight of the base polyether or polyurethane which typically range from 12000 MW up to 30000 MW.

The high viscosities of the alkoxysilane capped polyether using isocyanato silanes above the base viscosity of the polyether chain are due to the hydrogen bonding between adjacent polymer chains when urethane groups are formed in the reaction of the hydroxyl groups and the isocyanate of the isocyanato alkoxy silane. The urethane group has one double bonded oxygen atom attached to a carbon atom, and adjacent to the carbon atom is a nitrogen atom with a hydrogen atom. The electrostatic hydrogen bonding is developed between the double bonded oxygen atom, referred to as carbamate, and the hydrogen attached to a nitrogen atom in an adjacent polymer chain and this interchain bond increases the polymer viscosity. Standard methods to reduce this hydrogen bond viscosity increase in polyurethane prepolymers have been to add solvents, like Xylene, and plasticizers, like DIDP. The viscosity increase depends on the polymer design and the number or urethane groups. These solvents are dangerous and can pose a hazard to persons creating the alkoxysilane capped polyether as well as those who work with the product often.

To replace standard TDI and MDI based polyurethane prepolymers in polyurethane, silicone and other sealant market polymers in the existing adhesive markets, we need to give formulators and their factories a low toxicity, lower viscosity moisture curable alkoxysilane polymer and a method where the sealants are able to be manufactured in a very similar process to what is currently used. What is needed is stable lower viscosity alkoxysilane capped prepolymers or resins, in which moisture scavengers can be added, and cure inhibitors can be used. Such a composition would allow users to be able to formulate products that can be manufactured in equipment that is currently used for high volume PU sealant production. Also needed is a formulation that can replace current proven PU sealant formulations. Such formulation should be less process intensive and have advantages in physical properties such as UV exposure resistance. The replacement of the tin based DBTDL catalyst by less environmentally problematic catalysts is also needed.

Additionally, the moisture content of the currently used calcium carbonate and other mineral or synthetic mineral fillers and reinforcing fillers such as the precipitated calcium carbonate products of rhombic shape creates problems when producing single pack, room temperature curing RTV compositions. The production of these compounds requires low levels of residual moisture content. Current methods of eliminating the residual moisture content uses moisture scavengers that prevent premature cure in cartridges or the normal packaging used in all of these sealant and adhesive markets. Therefore, the needed composition should provide a final product with low residual moisture content.

What is needed is a method of producing an alkoxysilane capped polyether with lower viscosity that utilizes less toxic chemicals. The method also needs to eliminate free NCO groups and reduce the amount of moisture in the final product.

### SUMMARY OF THE INVENTION

An aspect of the present method is to provide an polymer production process for producing an alkoxysilane capped polyether with lower viscosity that utilizes less toxic chemicals. The method also eliminates free NCO groups and reduces the amount of moisture in the final product.

The above aspect can be achieved by an method of polymer production comprising:

Creating a polymeric composition by mixing polypropylene glycol, HDI, a reaction catalyst, and isosilane; and adding vinyl silane and methanol to reduce the viscosity of the polymeric composition.

### BRIEF DESCRIPTION OF THE DRAWINGS

Further features and advantages of the present product and method and various embodiments of the present product and method, will become apparent and more readily appreciated from the following description of the preferred embodiments, taken in conjunction with the accompanying drawings of which:

FIG. 1 is a flowchart showing the steps to create a first variant alkoxysilane capped polyether with lower viscosity, according to an embodiment;

FIG. 2 is a flowchart showing the steps to create a second variant alkoxysilane capped polyether with lower viscosity, according to an embodiment; and additional moisture scavenger;

FIG. 3 is a flowchart showing the steps to create a sealant product using a second variant alkoxysilane capped polyether with lower viscosity, according to an embodiment; and

FIG. 4 is a flowchart showing the steps to create an alkoxysilane capped polyether with lower viscosity, according to an embodiment.

### DETAILED DESCRIPTION

We have developed a new generation of alcoxysilane terminated polymers that have the low tin catalyst requirement of trimethoxy terminated polymers with lower viscosities in the range of 5000 to 30000 Mpas. We also disclose our discovery of an addition of commonly available moisture scavenger chemical, which will enable the formulator to have a sealant open time from 15 minutes to 1.0 hours. These discoveries allow for the formulation of a cheaper sealant with properties that are close to current PU formulations and allow the applicators a safer low toxicity product with minimal differences in application methods.

The polymers are composed of a backbone of polyurethane, polyether, polyester, polyacrylate, or can be any polymer of linear or cross linked composition with free reactive hydroxyl groups available for reaction. The design of the backbone is chosen to give the required hardness, tensile and elongation properties when reacting hydroxyl group with a trifunctional (trimethoxy or triethoxy) or difunctional (methyl dimethoxy) isocyanato silane to produce the alcoxysilane capped polymer. These can be commonly known gamma, beta, and alpha silanes. This use of isocyanato silanes is well documented. Depending on the content of the carbamate groups added, the current method of production for these isocyanato silanes results in a final product with viscosities that are 50% to 200% higher than those of the starting DMC process low monol polyether chains. The method of the present invention using DMC catalyst polyether based polymers results in sealants with excellent physical properties, including a lower viscosity, as shown in example formulations.

It has been found that these silane terminated polyethers are stable, but need to have a moisture scavenger and reaction retarder added at some stage in the manufacturing process. This way, the customer is able to manufacture sealants using various fillers, such as calcium carbonates, that have up to 500 ppm moisture present even after some drying process for these fillers. The common moisture scavengers used include: vinyl silanes; various faster carbamate silanes; as well as the family of moisture scavengers used by polyurethane formulations that include the oxyzoladine derivatives.

Unexpectedly, it has been found that a small amount of vinyl silane and methanol added together to the capped polymer where isocyanato silanes has been used has a dramatic effect on the viscosity of a trimethoxy or methyl dimethoxy silane capped polyether or polyurethane composition. The hydrogen bonding generated across adjacent urethane groups is reduced by up to 90%, when amounts as little as 0.5% vinyl silane and 0.5% methanol are added to the polymer after the reactions are completed and the polymer is cooled to below 40 degrees C. The total polymer viscosity reduction is in the order of 30% to 60% depending on the design and composition. The amount needed depends on the number of urethane bonds present in the polymer chain.

It has also been discovered that the addition of small amounts of vinyl silane and methanol to the polymer results in improved stability of the polymer when drums are opened during manufacturing with commonly used manufacturing equipment. When combined with a sealant manufacturing process, wherein residual moisture is reduced with heating under vacuum, these combined additives can reduce moisture content with the benefit of the methanol aiding residual moisture elimination from the fillers used by the azeotropic distillation process. It is well known that methanol reduces the reaction rate of alkoxysilanes, but needs to be used at low levels as methanol is toxic to humans in large quantities and should not be used at levels above 1% where it also has an effect on the flammability of the polymer.

It is common in PU sealant formulation practice in one part RTV sealants and adhesives to use the very toxic paratoluenesulphonicisocyanate, known as PTSI, as a fast moisture scavenger to reduce moisture content as the reaction is faster than the isocyanate containing polymer NCO groups. To date the sealant formulators using trimethoxy silane terminated polyether polymers have not had these options, as the known faster carbamate silanes do dry the powders, but also crosslink the polymer chains if the moisture content is not known and excess is added. There is also a need for the new trifunctional alkoxysilane resins to have a similar additive, and we have found that the oxyzoldines are a suitable moisture scavenging additive for the trimethoxy polymers with preference given to addition of Zoldine MS-PLUS moisture scavenger from the Angus Chemical Company, a Dow subsidiary. The additive can be incorporated into the resin or added during compounding at small levels to scavenge residual moisture, which is the preferred embodiment.

With these combinations of additives and reaction retarders, the present method results in a unique low viscosity polymer that has some flexibility in formulating, which provides the advantage of manufacturing RTV sealants and adhesives of lower toxicity. This process also provides a product to the RTV manufacturers that provides the ability to control curing rates in a similar method as currently used with the PU sealants commonly made. Below we provide some preferred embodiments of the present method, but it is understood that the inclusion of variations obvious to those skilled in the polymer manufacturing art are also contemplated.

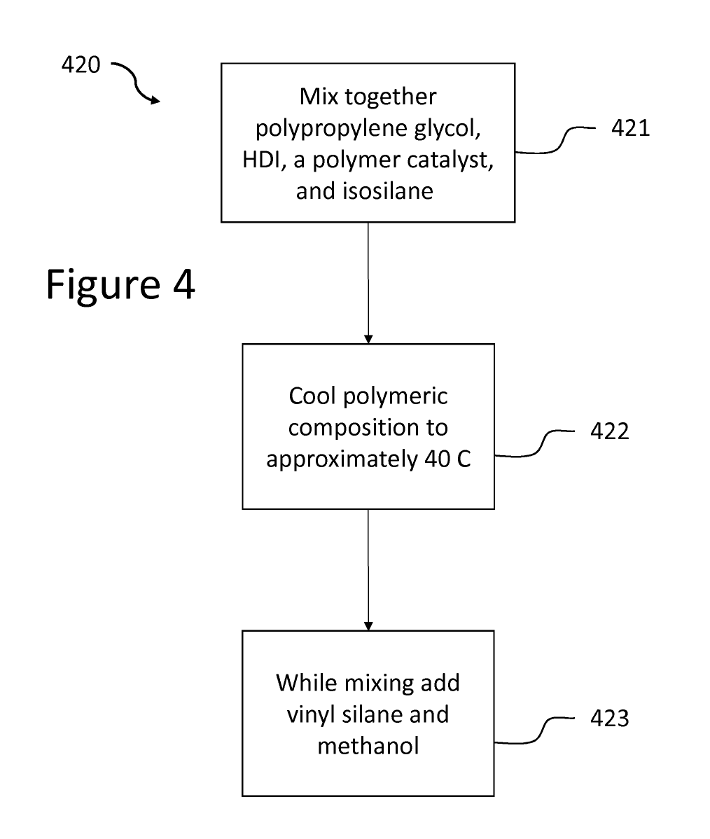

FIG. 4 is a flowchart showing the steps to create an alkoxysilane capped polyether with lower viscosity 410. A polypropylene glycol, HDI, a polymer catalyst, and isosilane can be mixed to create a polymeric composition 411. The polymeric composition can be cooled to approximate 40 degrees C. 412. After cooling, vinyl silane and methanol can be added to the polymeric composition 413 to reduce its viscosity. Preferably, but not necessary, the amounts of vinyl silane and methanol added to the polymeric composition can be equal. Also preferable, the amounts of vinyl silane and methanol should not exceed 1% by volume and should be greater than 0.4% by volume.

### Examples

The invention is described by reference to the specific examples for the purpose of illustration, and it is to be understood that numerous options will be apparent to those skilled in the art, and are considered to be within the scope of this invention.

### Test Methods

| | |
|---|---|
| Hardness | ASTM D2240 |
| Tensile strength | ASTM D412 |
| Elongation | ASTM D412 |

### Trimethoxy Silane Capped Hybrid Polymer A

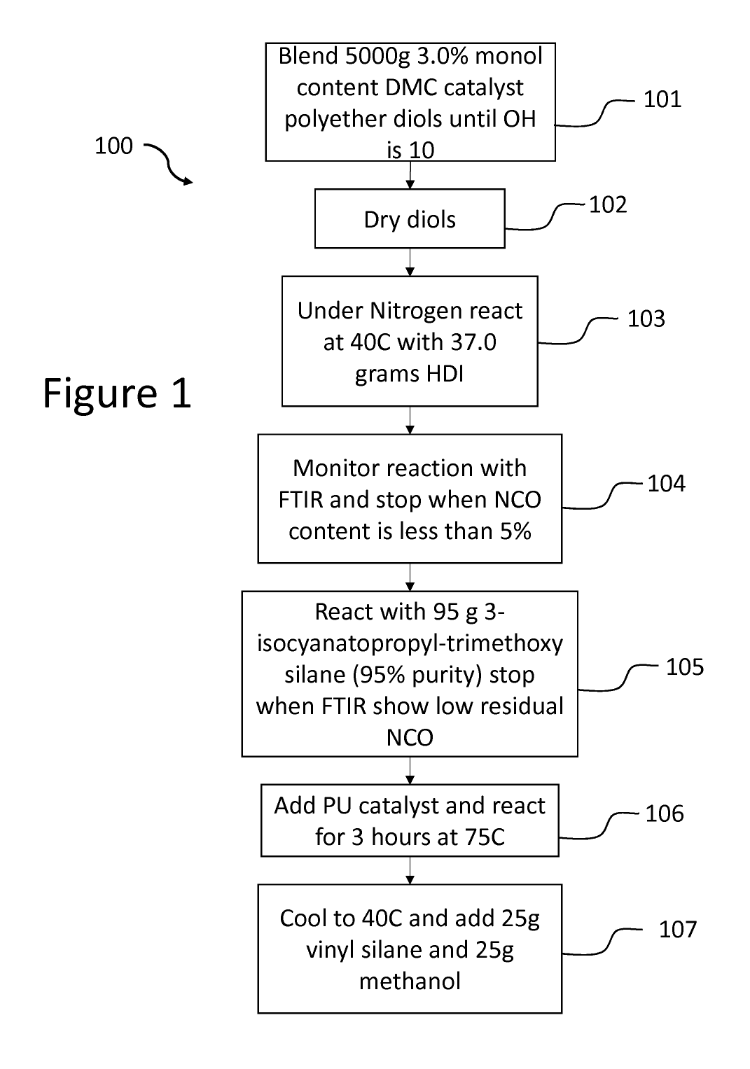

FIG. 1 is a flow chart showing the steps to create a first variant alkoxysilane capped polyether with lower viscosity, according to an embodiment. In a standard large glass laboratory flask with good stirring, 5000 grams of approximately 3.0% monol content, DMC catalyst process polyether diols can be blended to achieve an OH value of 10. These diols can be dried and reacted under nitrogen at 40 degrees C., with 37.0 grams HDI and monitored with FTIR. The reaction can be stopped when the NCO content is less than 5%, which can correspond to a chain extension of the polyether to approximately 25000 MW average. The remaining OH groups can then be reacted in a second step with 95 grams of 3-isocyanatopropyl-trimethoxy silane (95% purity) until the reaction shows low residual NCO by FTIR. The second reaction can be approximately 3 hours at 75 degrees C. using a well-known PU catalyst at low levels, an example of such a catalyst can include, DBTDL (Dibutyl tin dilaurate) or Tin free Coscat 83 Bismuth catalyst.

The above resin can then be cooled in the laboratory flask to 40 degrees C. and 25 grams of vinyl silane and 25 grams of anhydrous methanol can be added while mixing continues. A very immediate reduction in viscosity is apparent and the viscosity can be reduced to 30000 Mpas at 25 degrees C. after cooling and packaging in a 1 litre metal sample container. The viscosity of the above composition with no addition of methanol or vinyl silane is of the order of 70000 Mpas at 25 degrees C.

Any residual NCO group from the isocyanato silane reacts with the methanol immediately producing a carbamate silane. The absence of residual NCO groups can be shown by FTIR with the absence of any peak at 2242 cm⁻¹. Open time before skinning of this polymer when mixed with 1% DBTDL can be approximately 50 minutes at 25 degrees C. and 50% humidity in a laboratory glass dish. Shore A hardness can be approximately 22 to 25 after 7 days cure. The trimethoxy alcoxysilane terminated polymer can also cure with all of the tin metal containing catalysts such as DBTDL, DOTL, and the tin diketonate catalysts such as the Dow Chemical manufactured Metatin 740.

The addition of secondary amino silane adhesion promoter such as Shinetsu KBM603 at the 1% level combined with 1% DBTL can be used to increase the reaction rate, and at 25 degrees C. and 50% humidity, the open time of a resin sample using DBTDL and a secondary amino adhesion promoter is 8 minutes. The use of the synergy DBTDL and secondary amino silane which can be used for adhesion allows for very low levels of tin catalyst content to produce a 1 part RTV sealant or adhesive.

### Trimethoxy Silane Capped Hybrid Polymer A2

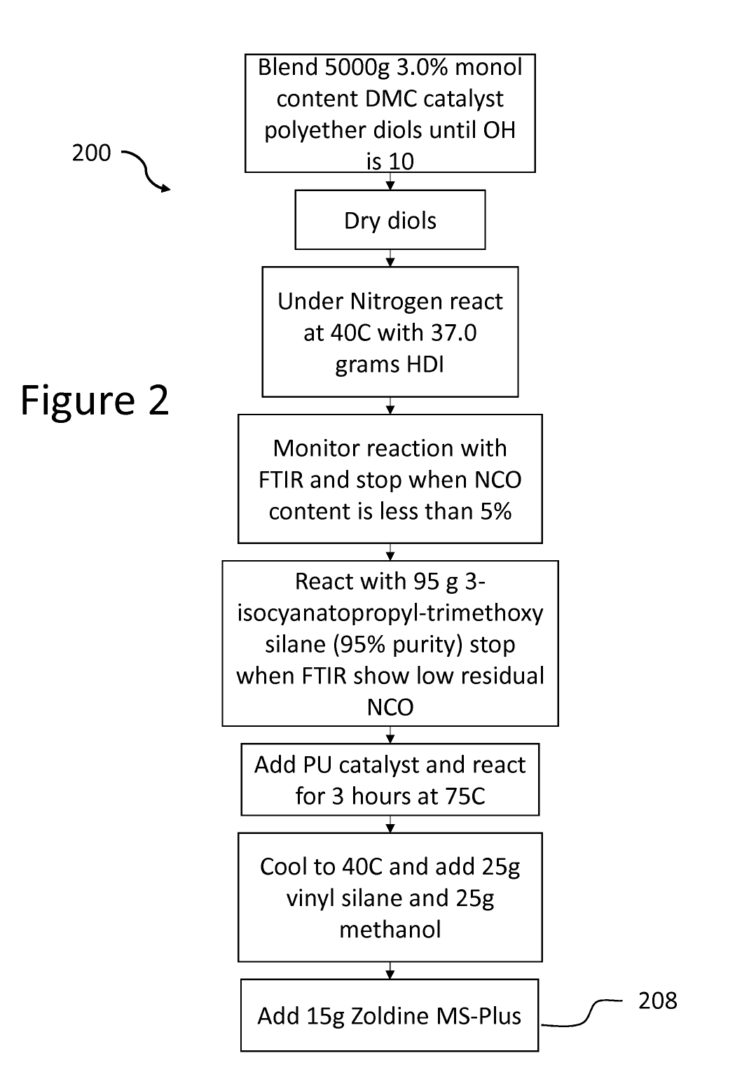

FIG. 2 is a flow chart showing the steps to create a second variant alkoxysilane capped polyether with lower viscosity, according to an embodiment. Polymer variant A2 is polymer A with the addition of a moisture scavenger additive. Therefore, all of the steps used to make the first variant alkoxysilane capped polyether as described above can be utilized for the second variant. These steps can also include the addition of a moisture scavenger, preferably 15 grams of Zoldine MS-Plus. The addition of the moisture scavenger additive can be made by the manufacturer prior to manufacturing where limited powder drying facilities are available and the manufacturer wishes to also chemically dry the powders used in the sealant. The moisture scavenger additive can be calculated or measured as there is also possibility of moisture in the plasticizer, which can be reduced in a number of ways, one of which is demonstrated here.

### Sealant Formulation with Hybrid Polymer A2

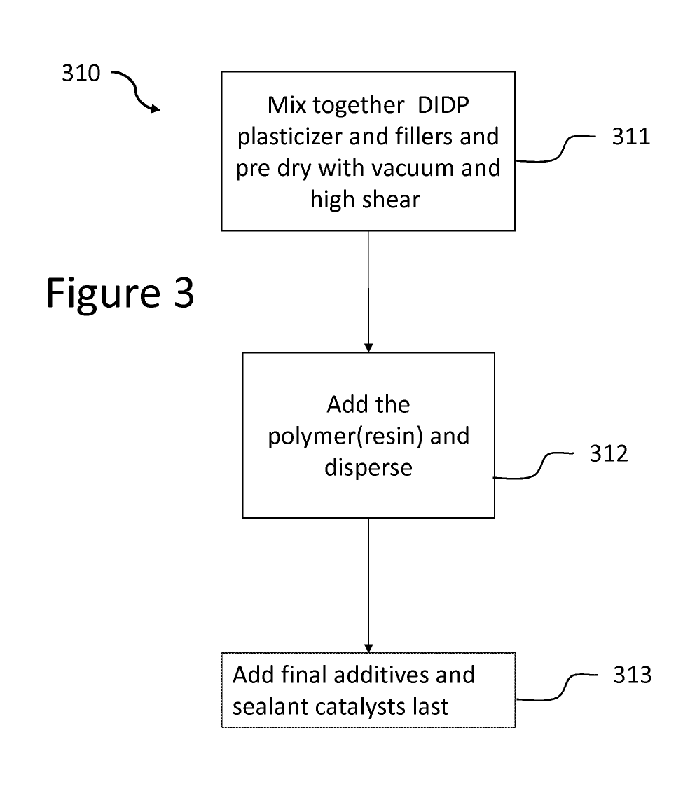

FIG. 3 is a flow chart showing the steps to create a sealant product using a second variant alkoxysilane capped polyether with lower viscosity 310, according to an embodiment. In a standard 5 litre laboratory planetary mixer, with nitrogen, vacuum and small press sealant samples from Hybrid polymer A2 can be produced, without good powder drying facilities. The calcium carbonate moisture levels in the DIDP and calcium carbonate first stage can be measured at about 1000 PPM.

The mixer contents can be heated and vacuum can be applied to aid moisture removal 311. The additional vinyl silane can be added to the DIDP plasticizer and mixing can be started, and then the resin (Polymer) addition 312. Therefore, the moisture scavenger can be present when the resin (Polymer) is added to the calcium carbonate and plasticizer. Final addition is other additives and the catalyst 313.

The base formulation is in parts, and can be adjusted for the mixer used and can be a softer construction sealant style composition.

| | | |
|---|---|---|
| Hybrid resin A2 | 100 | parts |
| DIDP plasticizer | 80 | parts |
| Vinyl silane | 1 | parts |
| PCC Takehara | 100 | parts |
| GCC omyacarb 2T | 100 | parts |
| TI02 Paint grade | 50 | parts |
| Amino KBM603 | 2 | parts |
| DBTDL catalyst | 1 | part |
| Tinuivin B75 | 3 | parts |
| Aerosil R202 | 10 | parts |

The mechanical properties of the above construction type joint sealant using Hybrid polymer A2 composition and packed into aluminium lined soft tube packaging, after a 7 day cure are shown below.

| | |
|---|---|
| Tack free time | 54 minutes |
| Viscosity Mpas | 1,200,000 |
| Slump mm | 0.0 (customer specific test) |
| VOC | 1.50 percent loss |
| SG g/cm3 | 1.44 |
| Tensile at break | 1.55 n/mm2 |
| Elongation % | 630 at break |
| Hardness Shore A | 32 |
| Adhesion to concrete | 95% cohesive after 30 days |
| Cartridge stability | >9.0 months in aluminium |
| | lined hermetic cardboard cartridge |

While the major embodiments of the invention are illustrated and described herein, it is not intended that these illustrate all possible uses of the invention, rather the example describes how the next generation of low viscosity hybrid polymers can be used to produce less toxic and commercially viable RTV compositions suitable as an alternative to current NCO containing polyurethane sealants and adhesives that often also contain some residual free TDI monomer and xylene solvent. The examples show sealant properties close to commercial PU sealants based on TDI isocyanate prepolymers. The polyether used can be blended to achieve a target OH value and consistent tensile properties and Shore A hardness of sealants can be very dependent on polyether number average molecular weight, the resulting OH value and polymer design. Resins or polymers with mixtures of diols and triols result in enhanced properties as is well known in the art of polyurethane technology.

This disclosure includes all products made using any of the methods described herein.

Although the present method of producing a low viscosity alkoxysilane capped polyether, as well as the present method for creating a sealant product using the low viscosity alkoxysilane capped polyether has been described in terms of exemplary embodiments, it is not limited thereto. Rather, the appended claims should be construed broadly, to include other variants and embodiments of the process and product, which may be made by those skilled in the art without departing from the scope and range of equivalents of the present inventive concept.

What is claimed is:

1. A method for manufacturing alcoxysilane capped polymers, the method comprising:
creating a polymeric composition by mixing polypropylene glycol, HDI, a polymer catalyst, and isosilane; and
adding vinyl silane and methanol to reduce the viscosity of the polymeric composition.

2. The method recited in claim 1 wherein the polymeric composition comprises polyurethane.

3. The method recited in claim 1 wherein the polymeric composition comprises polyether.

4. The method recited in claim 1 wherein the polymeric composition comprises polyester.

5. The method recited in claim 1 wherein the polymeric composition comprises polyacrylate.

6. The method recited in claim 1 wherein the vinyl silane and the methanol are added to the polymeric composition simultaneously.

7. The method recited in claim 1 wherein the concentration of methanol in the polymeric composition is greater than 0.4% and less than 1% by volume.

8. The method recited in claim 1 wherein the concentration of vinyl silane in the polymeric composition is greater than 0.4% and less than 1% by volume.

9. The method recited in claim 1 wherein the methanol and vinyl silane are added after the polymer reaction is completed and the polymer is cooled to below 40 degrees C.

10. The method recited in claim 9 wherein the concentration of methanol in the polymeric composition is greater than 0.4% and less than 1% by volume.

11. The method recited in claim 10 wherein the concentration of vinyl silane in the polymeric composition is greater than 0.4% and less than 1% by volume.

12. A low viscosity alkoxysilane capped polyether produced by the method disclosed in claim 1.

13. An adhesive or sealant comprising the low viscosity alkoxysilane capped polyether disclosed in claim 12.
